(19) United States
(12) Patent Application Publication
(10) Pub. No.: US 2005/0049869 A1
(43) Pub. Date: Mar. 3, 2005

(54) Macro-making for shorthand word processing

(76) Inventor: Patricia Bache, Seattle, WA (US)

Correspondence Address: PATRICIA BACHE, 7507 10th AVE NW, SEATTLE, WA, 98117-4110, US

(21) Appl. No.: 10/654,530

(22) Filed: Sep. 3, 2003

(51) Int. Cl. G10L 15/00

(52) U.S. Cl. 704/254

(57) ABSTRACT

“Macro-Making for Shorthand Word Processing” delineates methodology to build a macro database of megabyte size and more encoding categorical terminology such as medical and legal as well as common English usage. Wild card macro code ending letters z and zz enable encoding words to fullest inflection possible balancing with the inclusion of the most widely used words, phrases, sentences and standard abbreviations. This methodology is time and energy saving by reducing keystroking 30-50%, correspondingly increasing production. It may be self-taught, self-paced and selective in choosing how much to use: easy learning and easy typing.

“MACRO-MAKING FOR SHORTHAND WORD PROCESSING” is methodology with which to build a computer macro database in order to autotype words, phrases, sentences and standard abbreviations whenever macro code is key stroked. For words, phrases, sentences and standard abbreviations, wild card end-code letter(s) z resolve conflictive issues, differentiate gender or similitude, indicate less predominantly used term, plural or possessive case, and zz indicates plural possessive case;

WORD: The first three or four letters and last letter as necessary:

| | |
|---|---|
| ackn | acknowledge |
| acknd | acknowledged |
| ackne | acknowledgeable |
| ackns | acknowledges |
| acknsz | acknowledgements |
| acknt | acknowledgement |

WORD: First-two letters, next major syllable two letters, last letter as necessary:

| | |
|---|---|
| chho | childhood |
| chhoz | childhood's |
| hytee | hypertensive |
| hyteez | hypotensive |
| hyten | hypertension |
| hytenz | hypotension |
| lihed | lightheaded |
| lihes | lightheadedness |

WORD: First-two letters, next two letters of the most accented syllable, meaning where the voice is lifted more so than anywhere else, and last letter as necessary:

| | |
|---|---|
| chths | cholelithiasis |
| chthsz | choledocholithiasis |
| hytra | hypernatremia |
| hytraz | hyponatremia |

STANDARD ABBREVIATIONS: Doubling the first letter of the abbreviation:

| | |
|---|---|
| abg | ABG |
| aabg | arterial blood gas |
| abgs | ABGs |
| aabgs | arterial blood gases |
| egd | EGD |
| eegd | esophagogastroduodenoscopy |
| egds | EGDs |
| eegds | esophagogastroduodenoscopies |
| si | SI |
| ssi | sacroliac |
| ssiz | SSI |
| sssi | supplemental security income |
| sssiz | Supplemental Security Income |

TWO WORDS: First-two letters of first word, first-two letters of second word, last letter of second word as necessary:

| | |
|---|---|
| gesun | general surgeon |
| gesus | general surgeons |
| gesunz | general surgeon's |

PHRASE AND SENTENCE: Acronym of first letter of each word, last letter of last word:

| | |
|---|---|
| basisz | biting and shaving instruments |
| dsay | digital subtraction angiography |
| tpwsthrm | The patient was sent to his room. |
| tpwsthrmz | The patient was sent to her room. |

### CROSS-REFERENCE TO RELATED APPLICATION

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BRIEF DESCRIPTION OF THE SEVERAL VIEWS OF THE SEVERAL DRAWINGS

Not applicable.

### BACKGROUND

Researching shorthand word processing in 1997, I found computer software oriented to individual database creation, the programs themselves often incompatible with various computers. Since 1996, I am on my seventh database from scratch. This tedious megabyte rebuilding “happens” when switching jobs or computer crashes a non-backed-up database. Voice recognition technology providers profess 40% usage feasibility, if that, for a staff of a major hospital network. Helping hands with the hard work of word processing enhanced by shorthand methodology is a long-term necessity. Working toward a goal of a computer-embedded, standardized shorthand word processing database, I have at first obtained copyright Txu-067-159 Feb. 13, 2002 of unpublished “Medical Transcription Shorthand Word Processing,” not to be published until patent is secured.

### SUMMARY

“Macro-making for Shorthand Word Processing” is methodology of encoding text in order to build a computer macro database of words, phrases, sentences and standard abbreviations to autotype whenever the codes are key stroked. Words are encoded to fullest inflection possible. Seven ground rules apply to particular terminology selected, which is based on its most frequent and common usage by categorical professions such as medical or legal. With this methodology, achieving a most excellent, extensive database of megabyte size and more is possible, and the potential for standardization of shorthand word processing and a computer-embedded database, never to be lost, may be realized. An average reduction of keystroking in the 30-50% range with correspondingly increased production may be realized. In contrast to a grueling two-year court reporter/transcriptionist course, it is easy to learn, self-taught, self-paced and selective in that the individual may choose how much to use, and whatever chosen is the easiest to type. This is a time-and-energy-saving way to stop being a Sisyphus typing the same things the hard way over and over and over again.

### DESCRIPTION

“Macro-making for Shorthand Word Processing” is methodology with which to create a computer macro database enabling macro expansion of code to text which autotypes whenever the code is key stroked. In encoding the maximal amount of the most vastly used terminology applicable to categorical professions such as medical or legal, judicious selection of schematics is based on words, phrases, sentences and standard abbreviations' complexity, simplicity or singularity, the easiest to remember and type. Use of the fullest inflection of words is balanced with the inclusion of the most frequently used words. The ultimate reality of a computer-embedded shorthand word processing database, never to be lost, will depend upon a popular and standardized methodology. In contrast to multiple existent arbitrary techniques in the marketplace, seven congruent ground rules apply.

WILD CARD END-CODE LETTERS (LOWER CASE) z AND zz: For words, phrases, sentences and standard abbreviations, wild card end-code letter(s) z resolve conflictive issues, differentiate gender or similitude, indicate less predominantly used term, plural or possessive case, and zz indicates plural possessive case:

WORD: First three or four letters, last letter(s) z or zz as necessary. Technology provides corrective procedure to overwrite such as the macro code “crea” for creator should Creator be desired instead (same for proper name Cree instead of “cree” for the word “creative”), or the word may simply be typed in full.

| | |
|---|---|
| cre | create |
| cred | created |
| cres | creates |
| cree | creative |
| crey | creativity |
| creyz | creatively |
| cren | creation |
| crenz | creations |
| crea | creator |
| creas | creators |
| creaz | creator's |
| creazz | creators' |
| creat | creatinine |

WORD: The first-two letters, next major syllable two letters, last letter as necessary:

| | |
|---|---|
| chho | childhood |
| chhoz | childhood's |

WORD: The first-two letters, next two letters of the most accented syllable, meaning where the voice is lifted more so than anywhere else, and last letter:

| | |
|---|---|
| caecy | capsulectomy |
| pacil | parieto-occipital |

STANDARD ABBREVIATIONS: Doubling the first letter of standard abbreviation:

| | |
|---|---|
| ABG | aabg arterial blood gas |
| EGD | eegd esophagoduodenoscopy |

TWO WORDS: The first-two letters of the first word, first-two letters of the second word, last letter of the second word as necessary:

| | |
|---|---|
| gesun | general surgeon |
| sugel | Surgeon General |

PHRASE AND SENTENCE: Acronym of first letter of each word, last letter of last word:

| | |
|---|---|
| basisz | biting and shaving instruments |
| widsay | What is digital subtraction angiography? |

1. I, Patricia Bache, claim authorship of “Macro-making for Shorthand Word Processing” and invention of methodology therein specified to macro encode:
A word by the first three or four letters, last letter as necessary;
A word by the first-two letters, next major syllable two letters, last letter as necessary;
A word by the first-two letters, next two letters of the most accented syllable, meaning where the voice is lifted more so than anywhere else, last letter as necessary;
A standard abbreviation by doubling its first letter;
Two words by the first-two letters of the first word, first-two letters of the second word, last letter of last word as necessary;
A phrase or sentence by acronym of first letter of each word, last letter of last word as necessary;
And, wild card end-code letter(s) z in any case above to resolve conflictive issues, differentiate gender or similitude, indicate less predominantly used term, plural or possessive case and zz to indicate plural possessive case.
